(19) United States
(12) Patent Application Publication
(10) Pub. No.: US 2026/0118256 A1
(43) Pub. Date: Apr. 30, 2026

(54) SYSTEMS, DEVICES AND METHODS FOR CALCULATING A CORRECTION FACTOR TO CORRECT A BASELINE OF A RAMAN SPECTRUM GENERATED BY WAVEGUIDE-ENHANCED RAMAN SPECTROSCOPY TECHNOLOGY

(71) Applicant: INSPEK, Palaiseau (FR)

(72) Inventors: Jérôme MICHON, Palaiseau (FR); Priscille BONNASSIES, Palaiseau (FR); Christopher LIEUTAUD, Palaiseau (FR); Dorian SANCHEZ, Palaiseau (FR)

(21) Appl. No.: 19/165,048

(22) PCT Filed: Dec. 21, 2023
(86) PCT No.: PCT/EP2023/087454

§ 371 Date: Sep. 12, 2025

(30) Foreign Application Priority Data
Mar. 14, 2023 (FR) FR2302333

(51) Int. Cl. G01N 21/27; G01J 3/02; G01J 3/44; G01N 21/65

(52) U.S. Cl. CPC G01N 21/274; G01J 3/0218; G01J 3/44; G01N 21/658; G01N 2201/08

(57) ABSTRACT

One of the objectives of this invention is to provide a method for correcting the baseline of a Raman spectrum which takes into account the phenomena at the origin of the baseline that are specific to waveguide-enhanced Raman spectroscopy. The solution of the invention corrects the baseline of a Raman spectrum that is caused by physical elements that constitute the device implementing waveguide-enhanced Raman spectroscopy. Known baseline correction methods can then be used before removing the baseline from the acquired Raman spectrum.

### TECHNICAL FIELD

The invention relates to the field of processing of Raman signals. In particular, it relates to a system, a semiconductor device and a method for calculating a correction factor to correct the baseline of a Raman spectrum generated by a waveguide-enhanced Raman spectroscopy technology.

### PRIOR ART

In the context of Raman spectroscopy, it is known that the performance of the spectral analysis of a Raman spectrum can be severely degraded by undesirable signals, known as the “baseline”.

In a known manner, in Raman spectroscopy the baseline is considered to be due either to Rayleigh scattering or to the fluorescence of certain organic molecules (i.e., the emission of light at a certain wavelength by a substance irradiated at another wavelength) which originate from the samples analysed.

As such, many methods are known for correcting the baseline of Raman spectra.

However, none of these take into account the specificity of the baseline of Raman spectra acquired by sensors using waveguide-enhanced Raman spectroscopy (WERS).

Indeed, with this technology, for example, the waveguide material, in which the optical wave propagates, also produces a Raman effect and thus contributes to the formation of the baseline.

Thus, there is a need for a method for baseline correction of a Raman spectrum that takes into account the particularities of waveguide-enhanced Raman spectroscopy.

### SUMMARY OF THE INVENTION

The invention aims to, at least partially, solve this need.

A first aspect of the invention concerns a system for calculating a correction factor to correct a baseline of a Raman spectrum acquired by at least one waveguide-enhanced Raman spectroscopy device, referred to as an on-chip Raman sensor.

In practice, the on-chip Raman sensor is designed to implement a waveguide-enhanced Raman spectroscopy technique and which, in response to irradiation of at least one excitation radiation on a continuous fluid medium to be studied, referred to as an analyte medium, having at least one first refractive index, is configured to acquire a first optical spectrum, referred to as a first Raman spectrum, which comprises a plurality of discrete wavelengths and which is representative of the analyte medium.

Furthermore, the system also comprises at least one memory.

In addition the on-chip Raman sensor comprises a substrate which defines at least one surface, and at least one optical waveguide which is formed in an optical transmission material, which is all or in part disposed on or in the substrate, and which is configured to guide at least one light beam at at least one working wavelength.

Furthermore, the memory is configured to store a database, each record of which is configured to associate a correction factor with an analyte medium, a predetermined reference medium, a working wavelength, a first refractive index of the analyte medium and a second refractive index of the predetermined reference medium.

In practice, each correction factor is designed to correct the baseline of a second optical spectrum, referred to as the second Raman spectrum, the baseline being caused by the on-chip Raman sensor during the generation of the second Raman spectrum, in response to the irradiation of at least one excitation radiation on a predetermined reference medium which has at least one second refractive index, different from the first refractive index, the second Raman spectrum comprising a plurality of discrete wavelengths and being representative of the predetermined reference medium.

Finally, each correction factor corresponds, for each wavelength of the first Raman spectrum, to a ratio between, on the one hand, a first parameter referred to as the first Raman conversion efficiency parameter, which describes the Raman conversion efficiency of the on-chip Raman sensor in the predetermined reference medium, and, on the other hand, a second parameter referred to as the second Raman conversion efficiency parameter, which describes the Raman conversion efficiency of the on-chip Raman sensor in the analyte medium.

In an embodiment of the first aspect of the invention, the system also comprises at least one processor.

In addition, the memory is also configured to store processor-executable instructions.

The processor-executable instructions implement a step of correcting the baseline of the second Raman spectrum on the basis of at least one correction factor, so as to obtain a corrected second Raman spectrum which is representative of the baseline of the first Raman spectrum, the baseline being caused by the on-chip Raman sensor during the acquisition of the first Raman spectrum.

In addition, the processor-executable instructions also implement a step of subtracting the corrected second Raman spectrum from the first Raman spectrum.

Finally, the processor is configured to execute the executable instructions.

A second aspect of the invention relates to a semiconductor device for calculating a correction factor to correct a baseline of a Raman spectrum acquired by said semiconductor device.

In practice, the semiconductor device is designed to implement a waveguide-enhanced Raman spectroscopy technique and is configured, in response to irradiation of at least one excitation radiation on a continuous fluid medium to be studied, referred to as an analyte medium, having at least one first refractive index, to acquire a first optical spectrum, referred to as a first Raman spectrum, which comprises a plurality of discrete wavelengths and which is representative of the analyte medium.

In addition, the semiconductor device comprises a substrate which defines at least one surface, and at least one optical waveguide, which is formed in an optical transmission material, which is all or in part disposed on or in the substrate, and which is configured to guide at least one light beam at at least one working wavelength.

Furthermore, the semiconductor device also comprises at least one memory which is configured to store a database, each record of which is configured to associate a correction factor with an analyte medium, a predetermined reference medium, a working wavelength, a first refractive index of the analyte medium and a second refractive index of the predetermined reference medium.

In practice, each correction factor is designed to correct the baseline of a second optical spectrum, referred to as the second Raman spectrum, which is caused by the semiconductor device during the generation of the second Raman spectrum, in response to the irradiation of at least one excitation radiation on a predetermined reference medium which has at least one second refractive index, different from the first refractive index, the second Raman spectrum comprising a plurality of discrete wavelengths and being representative of the predetermined reference medium.

Finally, each correction factor corresponds, for each wavelength of the first Raman spectrum, to a ratio between, on the one hand, a first parameter referred to as the first Raman conversion efficiency parameter, which describes the semiconductor device Raman conversion efficiency in the predetermined reference medium, and, on the other hand, a second parameter referred to as the second Raman conversion efficiency parameter, which describes the semiconductor device Raman conversion efficiency in the analyte medium.

In an embodiment of the second aspect of the invention, the semi-conductor device also comprises a processor.

In addition, the memory is also configured to store processor-executable instructions.

In practice, the processor-executable instructions implement a step of correcting the baseline of the second Raman spectrum on the basis of at least one correction factor, so as to obtain a corrected second Raman spectrum which is representative of the baseline of the first Raman spectrum, the baseline being caused by the semiconductor device during the acquisition of the first Raman spectrum.

In addition, the processor-executable instructions also implement a step of subtracting the corrected second Raman spectrum from the first Raman spectrum.

Finally, the processor is configured to execute the executable instructions.

A third aspect of the invention relates to a computer implemented method for calculating a correction factor to correct a baseline of a Raman spectrum acquired by at least one waveguide-enhanced Raman spectroscopy device, referred to as an on-chip Raman sensor.

In practice, the on-chip Raman sensor, which is designed to implement a waveguide-enhanced Raman spectroscopy technique and which, in response to irradiation of at least one excitation radiation on a continuous fluid medium to be studied, referred to as an analyte medium, having at least one first refractive index, is configured to acquire a first optical spectrum, referred to as a first Raman spectrum, which comprises a plurality of discrete wavelengths and which is representative of the analyte medium.

In particular, the on-chip Raman sensor comprises a substrate which defines at least one surface, and at least one optical waveguide which is formed in an optical transmission material, which is all or in part disposed on or in the substrate, and which is configured to guide at least one light beam at at least one working wavelength.

In addition, the method comprises a step of acquiring a second optical spectrum, referred to as the second Raman spectrum, by the on-chip Raman sensor (110), in response to the irradiation of at least one excitation radiation on a predetermined reference medium which has at least one second refractive index different from the first refractive index, the second Raman spectrum comprising a plurality of discrete wavelengths and being representative of the predetermined reference medium, the second-generation Raman spectrum causing the formation of a baseline of the second Raman spectrum,

Then, the method also comprises a first calculation step, by the processor, for each wavelength of the first Raman spectrum, of a first parameter, referred to as the first Raman conversion efficiency parameter, which describes the efficiency of Raman conversion for the on-chip Raman sensor in the predetermined reference medium,

Next, the method also comprises a second calculation step, by a processor, for each wavelength of the first Raman spectrum, of a second parameter, referred to as the second Raman conversion efficiency parameter, which describes the efficiency of Raman conversion for the on-chip Raman sensor in the analyte medium.

Finally, the method also comprises a third calculation step, by a processor, for each wavelength of the first Raman spectrum, of a correction factor which corresponds to ratio between the first Raman conversion efficiency parameter and the second Raman conversion efficiency parameter.

In a first embodiment of the third aspect of the invention, the first calculation step and the second calculation step are carried out on the basis of an optical simulation of at least one optical mode of the optical waveguide of the on-chip Raman sensor.

In a second embodiment of the third aspect of the invention, the third calculation step comprises dividing the first Raman conversion efficiency parameter by the second Raman conversion efficiency parameter.

In a third embodiment of the third aspect of the invention, the method further comprises a step of storing, by a processor, the correction factor in a database, each record of which is configured to associate a correction factor with an analyte medium, a predetermined reference medium, a working wavelength, a first refractive index of the analyte medium and a second refractive index of the predetermined reference medium.

In a fourth embodiment of the third aspect of the invention, the predetermined reference medium is a continuous fluid medium.

In a fifth embodiment of the third aspect of the invention, the predetermined reference medium is a continuous solid medium.

In a sixth embodiment of the third aspect, the method further comprises a step of correcting the baseline of the second Raman spectrum, by a processor, on the basis of at least one correction factor, thus making it possible to obtain a corrected second Raman spectrum which is representative of the baseline of the first Raman spectrum, the baseline being caused by the semiconductor device during the acquisition of the first Raman spectrum.

Finally, the method also comprises a step of subtraction, by a processor, of the corrected second Raman spectrum from the second Raman spectrum.

In a first implementation of the sixth embodiment of the third aspect of the invention, the step of correcting the baseline of the second Raman spectrum comprises a multiplication of the second Raman spectrum by at least one correction factor associated with a wavelength of the first Raman spectrum.

In a second implementation of the sixth embodiment of the third aspect of the invention, the method further comprises a step of selecting, by a processor, the correction factor in a database as a function, at least, of the analyte medium, the predetermined reference medium, the first refractive index of the analyte medium, the second refractive index of the predetermined reference medium and the working wavelength.

### BRIEF DESCRIPTION OF THE DRAWINGS

Other features and advantages of the invention will be better understood on reading the following description with reference to the attached drawings, given for illustrative purposes and in no way limiting.

FIG. 1 shows Raman spectra and their associated baseline.

FIG. 2 shows a system according to the invention.

FIG. 3 shows a view from above of a device according to the invention.

FIG. 4 shows a method for calculating a correction factor according to the invention.

For the purposes of illustration, the figures do not necessarily reflect the scales, in particular in terms of thickness.

### DESCRIPTION OF THE EMBODIMENTS

In order not to obscure the description and distract the reader from understanding the teachings of the invention, explanations here will not go beyond what is considered necessary for understanding and appreciating the underlying concepts of the invention. Indeed, the embodiments illustrated in the description are, for the most part, composed of elements known to a person skilled in the art.

The context in which the invention is implemented is that of waveguide-enhanced Raman spectroscopy (WERS).

In practice, Raman spectroscopy probes are generally used in the fields of biochemical detection, research or biochemical production.

This is the case, for example, when it is desired to analyse the chemical composition of liquid mixtures in industry.

Simply described, Raman spectroscopy consists in illuminating a material to be analysed so as to cause the molecular bonds of which it is composed to vibrate. These vibrations take the form of a secondary photonic emission, the wavelength shift of which relative to the exciting wave, known as the Raman effect, represents a characteristic signature of each bond, known as the Raman spectrum.

The Raman spectra thus obtained are ultimately the specific image of the molecule or molecules present in the light field.

Thus, with this technology, it is possible to identify the molecules in a sample, because each peak in the Raman spectrum is associated with a vibrational mode of a molecule (and also of the rotational mode in the case of gases).

In other words, each vibrational frequency is specific to the chemical bond and to the symmetry of a molecule, so that the intensity peaks of a Raman spectrum reveal qualitative and quantitative information about the nature of the vibrational molecular dynamics of a sample (e.g. frequency, symmetry of vibrations, etc.) .

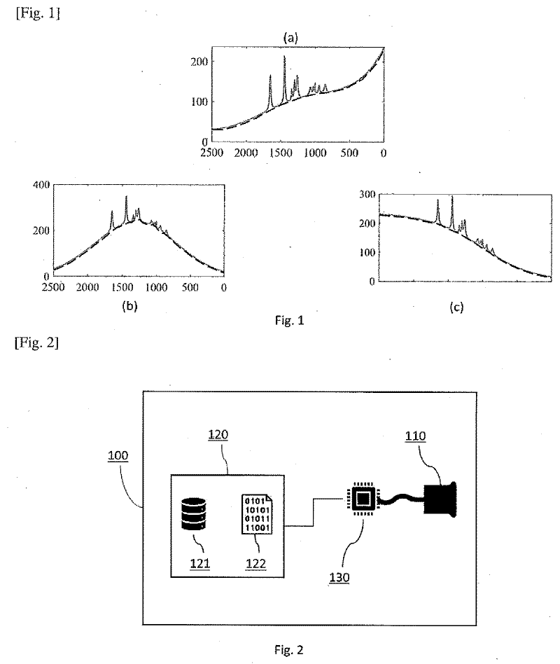

FIG. 1 illustrates three examples of Raman spectra, (a), (b) and (c).

In FIG. 1, the abscissa of these spectra indicates the Raman shift, which corresponds to the jumps in energy between the fundamental vibrational levels and is expressed in cm⁻¹ (wave number that reflects the direct proportionality between energy and the inverse of the wavelength of electromagnetic radiation).

In FIG. 1, the ordinate of these spectra corresponds to the Raman intensity for each wave number.

As shown in FIG. 1, the spectra (a), (b) and (c) each comprise a baseline which is illustrated as a dashed line.

In the context of waveguide-enhanced Raman spectroscopy, the inventors have identified phenomena which are intrinsic or extraneous to the spectroscopy experiment and which contribute to the baseline.

In waveguide-enhanced Raman spectroscopy, a monochromatic laser-type light signal is guided in a waveguide. The evanescent field of the guided light (i.e. the part of the light that is physically present outside the waveguide) then excites the sample molecules in the vicinity of the waveguide. In response to this excitation, these molecules emit Raman radiation. Finally, some of this Raman radiation is collected in the waveguide, where it constitutes a Raman signal of interest.

Consequently, for example, the waveguide material, in which the light signal propagates, also produces a Raman effect and thus contributes to the formation of the baseline.

This is also the case for the other physical elements that make up the device implementing the waveguide-enhanced Raman spectroscopy.

However, known methods for correcting the baseline of a Raman spectrum do not take into account these phenomena, which are specific to waveguide-enhanced Raman spectroscopy.

More specifically, in a known method referred to as “calibration”, the baseline of a Raman spectrum is eliminated by using a reference measurement which is subtracted from the actual measurement.

However, this method can only work in the context of conventional Raman spectroscopy, in which the baseline contribution of the device implementing conventional Raman spectroscopy is constant, whatever the medium analysed. This is not the case in waveguide-enhanced Raman spectroscopy, where the baseline contribution of the device performing waveguide-enhanced Raman spectroscopy varies as a function of the refractive index of the medium being analysed, since this alters the confinement of the optical mode.

In addition, in a known method of algorithmic processing, the baseline of a Raman spectrum is eliminated by modelling (e.g. by regression) the signal associated with the baseline directly on the actual measurement, before subtracting it from the actual measurement.

However, this method has two disadvantages

Firstly, this method requires assumptions to be made about the signal associated with the actual measurement, in order to be able to separate the contribution of the line from that of the actual measurement of the molecules investigated.

Then, in this method, the processing algorithm must be changed as soon as the medium analysed changes, since in this case the baseline also changes. Thus, an algorithm-based processing may work under some conditions, but be ineffective under other conditions.

The solution of the invention can solve the problems identified in the prior art, through the ability to correct the baseline of a Raman spectrum which is caused by all or some of the physical elements which constitute the device implementing waveguide-enhanced Raman spectroscopy.

Next, known baseline correction methods can be used before removing the baseline from the acquired Raman spectrum.

With the solution of the invention, the signal-to-noise ratio of the acquired Raman signal can be improved, in particular with a better detection limit than in the prior art.

### First Aspect of the Invention: A System for Calculating a Correction Factor to Correct a Baseline of a Raman Spectrum

As illustrated in FIG. 2, the invention relates to a system 100 for correcting a baseline of a Raman spectrum.

Herein, the term “system” shall mean a set of interconnected elements which exert an influence on one another.

In practice, the system 100 comprises at least one waveguide-enhanced Raman spectroscopy device, known as an on-chip Raman sensor 110, at least one memory 120, and at least one processor 130.

Thus, the system 100 may comprise two or more first on-chip Raman sensors 110, two or more memories 120 and/or two or more processors 130.

In the invention, the on-chip Raman sensor 110 is designed to implement a waveguide-enhanced Raman spectroscopy technique, as briefly described above.

In practice, in response to the irradiation of at least one excitation radiation onto a continuous fluid medium to be studied, referred to as the analyte medium, the on-chip Raman sensor 110 is configured to acquire a first optical spectrum, referred to as the first Raman spectrum, which is representative of the analyte medium.

In this way, the on-chip Raman sensor 110 can acquire the first Raman spectrum in response to the irradiation of two or more excitation radiations on the analyte medium.

In practice, the excitation radiation is an optical field (also called an optical electric field).

In the invention, the analytical medium has at least one first refractive index.

Thus, the analytical medium may comprise two or more first refractive indices.

In a first example, the analyte medium comprises at least one liquid.

In a second example, the analyte medium comprises at least one gas.

Furthermore, in the invention, the first Raman spectrum comprises a plurality of discrete wavelengths.

Conventionally, the on-chip Raman sensor 110 comprises a substrate.

Herein, the term “substrate” shall mean an entirely semiconductor support (e.g. silicon), a stack of semiconductor layers, a support which comprises non-homogeneous structures, a support which comprises electronic components or parts of electronic components at more or less advanced stages of their production.

Furthermore, the on-chip Raman sensor 110 comprises at least one optical waveguide (not shown).

Thus, the on-chip Raman sensor 110 may comprise two or more optical waveguides.

Herein, the term “optical waveguide” shall mean an optical device (e.g. an optical fibre) which has light trapping properties. In particular, its physical properties enable it to guide and optimally concentrate a luminous flux passing through it, in the visible or non-visible spectrum, towards a device which can collect it.

In a first example, the optical waveguide is a single-mode optical waveguide.

In a second example, the optical waveguide is a multimode optical waveguide.

In the invention, the substrate defines at least one surface.

Thus, the substrate may comprise two or more surfaces.

In a first example of the substrate surface, said surface is substantially planar and generally horizontally oriented.

In a second example of the substrate surface, said surface is non-planar and generally horizontally oriented.

In a third example of the substrate surface, said surface is curved and generally vertically oriented.

In a fourth example of the substrate surface, said surface is generally inclined with respect to the horizontal.

However, other shapes of substrate surface are possible according to need, without requiring substantial modifications of the invention.

Furthermore, the optical waveguide is formed from an optically transmissive material.

In a first example of optical waveguide material, the material comprises glass, such as silicon dioxide (SiO2), chalcogen elements, so-called chalcogenide glass fibre (e.g. sulfur, selenium or tellurium).

In a second example of optical waveguide material, the material comprises plastic, such as transparent polymers (e.g. polymethyl methacrylate (PMMA), polystyrene (PS) and polycarbonate (PC)).

In a third example of optical waveguide material, the material comprises semiconductors based on silicon (Si), gallium arsenide (GaAs) and/or gallium nitride (GaN).

However, it may be possible to use other materials to form the optical waveguide according to need, without requiring substantial modifications to the invention.

In practice, the optical waveguide is all or in part disposed on or in the substrate.

In a first implementation of the optical waveguide, all or part thereof is disposed on the substrate.

In a second implementation of the optical waveguide, all or part thereof is disposed in the substrate.

In this second implementation of the optical waveguide, a first portion of the optical waveguide is outside of the substrate, while a second portion of the optical waveguide is inside the substrate.

In a first example, the optical waveguide has a ratio, between the proportions of the first portion and the second portion, of 85/15.

In a second example, the optical waveguide has a ratio between the proportions of the first portion and the second portion of 75/25.

In a third example, the optical waveguide has a ratio between the proportions of the first portion and the second portion of 50/50.

However, other values of the ratio between the proportions of the first portion and the second portion are possible according to need, without requiring substantial modifications to the invention.

In addition, the optical waveguide is configured to guide, in at least one given optical propagation mode, at least one light beam at at least one working wavelength, along at least one light propagation direction.

Thus, the optical waveguide can guide, in at least one given optical propagation mode, two or more light beams at two or more working wavelengths, along two or more light propagation directions.

In a first example of the optical waveguide, the light beam is a laser beam emitted in the visible spectrum

In a second example of the optical waveguide, the light beam is a laser beam emitted in the non-visible spectrum (e.g. UV or near infrared).

In the invention, the memory 120 is of known type (e.g. RAM, ROM or EEPROM) and is configured to store a database 121 and, in a particular embodiment, processor-executable instructions 122.

In the database 121, each record is configured to associate a correction factor with an analyte medium, a predetermined reference medium, a working wavelength, a first refractive index of the analyte medium and a second refractive index of the predetermined reference medium.

In the invention, each correction factor is designed to correct the baseline of a second optical spectrum, referred to as the second Raman spectrum, which is representative of a predetermined reference medium.

In practice, the baseline to be corrected is caused by the on-chip Raman sensor 110 during the generation of the second Raman spectrum, in response to the irradiation of at least one excitation radiation onto the predetermined reference medium.

Thus, the predetermined reference medium may comprise two or more second refractive indices.

In a particular implementation, the baseline to be corrected is caused by an on-chip Raman sensor that is similar or identical to the on-chip Raman sensor 110.

In the invention, the predetermined reference medium has at least a second refractive index which is different from the first refractive index.

In a first implementation of the predetermined reference medium, this produces substantially no Raman response.

In a first example, the predetermined reference medium is water.

In a first example, the predetermined reference medium is air.

However, as required, it may be possible to use other predetermined reference media, without requiring any substantial modification of the invention.

In a second implementation of the predetermined reference medium, this produces a known Raman response.

Furthermore, the second Raman spectrum comprises a plurality of discrete wavelengths.

In the invention, a correction factor corresponds, for each wavelength of the first Raman spectrum, to a ratio between, on the one hand, a first parameter referred to as the first Raman conversion efficiency parameter, which describes the Raman conversion efficiency of the on-chip Raman sensor 110 in the predetermined reference medium, and, on the other hand, a second parameter referred to as the second Raman conversion efficiency parameter, which describes the Raman conversion efficiency of the on-chip Raman sensor 110 in the analyte medium.

In a known manner, Raman conversion efficiency is a measure of the strength of the Raman signal which is generated by a given material.

Formulas for calculating Raman conversion efficiency can be found, in particular, in the literature, for example, in the following articles:
equation (8) in: Ali Raza, Stéphane Clemmen, Pieter Wuytens, Michiel de Goede, Amy S. K. Tong, Nicolas Le Thomas, Chengyu Liu, Jin Suntivich, Andre G. Skirtach, Sonia M. Garcia-Blanco, Daniel J. Blumenthal, James S. Wilkinson, and Roel Baets, ‘High index contrast photonic platforms for on-chip Raman spectroscopy,’ Opt. Express 27, 23067-23079 (2019),
equation (S22) in: Derek M. Kita, Jérôme Michon, Steven G. Johnson, and Juejun Hu, ‘Are slot and sub-wavelength grating waveguides better than strip waveguides for sensing?,’ Optica 5, 1046-1054 (2018),
equation (13) in: Todd H. Stievater, Jacob B. Khurgin, Scott A. Holmstrom, Dmitry A. Kozak, Marcel W. Pruessner, William S. Rabinovich, R. Andrew McGill, ‘Nanophotonic waveguides for chip-scale raman spectroscopy: Theoretical considerations,’ Proc. SPIE 9824, Chemical, Biological, Radiological, Nuclear, and Explosives (CBRNE) Sensing XVII, 982404 (12 May 2016), and
Paragraph III. B in: Y. Li, H. Zhao, A. Raza, S. Clemmen and R. Baets, ‘Surface-Enhanced Raman Spectroscopy Based on Plasmonic Slot Waveguides With Free-Space Oblique Illumination,’ in IEEE Journal of Quantum Electronics, vol. 56, no. 1, pp. 1-8, February 2020, Art no. 7200108, doi: 10.1109/JQE.2019.2946839.

In practice, the Raman conversion efficiency is defined as a ratio of the intensity of the emitted Raman signal to the intensity of the incident laser light.

As a reminder, as mentioned above, the Raman signal is scattered light that is emitted when the incident laser light interacts with molecular vibrations in the material.

In particular, the Raman conversion efficiency depends on the properties of the material, as well as the parameters of the experiment, such as the wavelength of the laser, the polarisation of the light and the temperature.

In a particular implementation of the correction factor, the correction factor corresponds to a division of the first Raman conversion efficiency parameter by the second Raman conversion efficiency parameter.

Furthermore, in the invention, the processor-executable instructions 122 implement a step of correcting the baseline of the second Raman spectrum on the basis of at least one correction factor, so as to obtain a corrected second Raman spectrum which is representative of the baseline of the first Raman spectrum, the baseline being caused by the on-chip Raman sensor 110 during the acquisition of the first Raman spectrum.

Thus, the processor executable instructions 122 can implement a step of correcting the baseline of the second Raman spectrum based on two or more correction factors.

In a particular implementation of the step of correcting the baseline of the second Raman spectrum, the step comprises a multiplication of the second Raman spectrum by at least one correction factor associated with a wavelength of the first Raman spectrum.

Thus, this particular implementation of the step of correcting the baseline of the second Raman spectrum may comprise a multiplication of the second Raman spectrum by two or more correction factors respectively associated with a wavelength of the first Raman spectrum.

Furthermore, in the invention, the processor-executable instructions 122 also implement a step of subtracting the corrected second Raman spectrum from the first Raman spectrum.

Finally, in the invention, the processor 130 is of known type (e.g., a state machine, microprocessor, or microcontroller) and is configured to execute the executable instructions 122.

Now that the features of the system 100 have been described, a semiconductor device will be described for calculating a correction factor to correct a baseline of a Raman spectrum.

### Second Aspect of the Invention: A Semiconductor Device for Calculating a Correction Factor to Correct a Baseline of a Raman Spectrum Acquired by Said Semiconductor Device

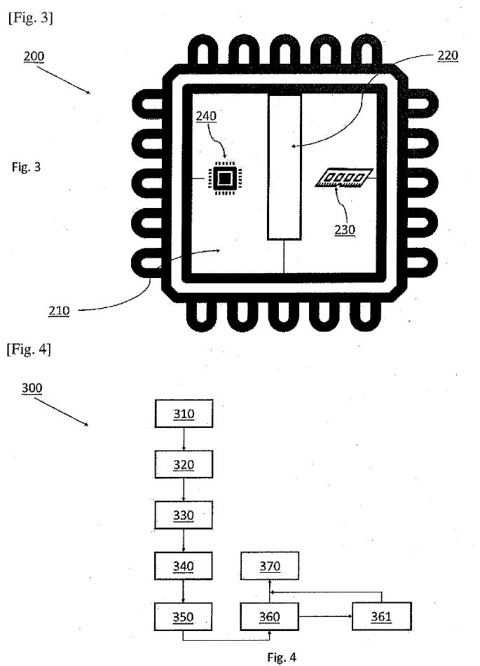

As illustrated in FIG. 3, the invention also relates to a single semiconductor device 200 which is designed to implement a waveguide-enhanced Raman spectroscopy technique and which incorporates all of the features of the system 100.

In practice, the semiconductor device is configured, in response to irradiation of at least one excitation radiation on a continuous fluid medium to be studied, referred to as an analyte medium, having at least one first refractive index, to acquire a first optical spectrum, referred to as a first Raman spectrum, which comprises a plurality of discrete wavelengths and which is representative of the analyte medium.

In addition, the semiconductor device 200 comprises a substrate 210, at least one optical waveguide 220, at least one memory 230 and at least one processor 240, as described above.

In particular, the substrate 210 defines at least one surface.

Furthermore, the optical waveguide 220 is formed in an optical transmission material, which is all or in part disposed on or in the substrate 210 and is configured to guide at least one light beam at at least one working wavelength,

The memory 230 is configured to store a database, each record of which is configured to associate a correction factor with an analyte medium, a predetermined reference medium, a working wavelength, a first refractive index of the analyte medium and a second refractive index of the predetermined reference medium.

In practice, each correction factor is designed to correct the baseline of a second optical spectrum, referred to as the second Raman spectrum, which is caused by the semiconductor device (200) during the generation of the second Raman spectrum, in response to the irradiation of at least one excitation radiation on a predetermined reference medium which has at least one second refractive index, different from the first refractive index, the second Raman spectrum comprising a plurality of discrete wavelengths and being representative of the predetermined reference medium.

In addition, each correction factor corresponds, for each wavelength of the first Raman spectrum, to a ratio between, on the one hand, a first parameter referred to as the first Raman conversion efficiency parameter, which describes the Raman conversion efficiency of the semiconductor device (200) in the predetermined reference medium, and, on the other hand, a second parameter referred to as the second Raman conversion efficiency parameter, which describes the Raman conversion efficiency of the semiconductor device (200) in the analyte medium.

In an embodiment of the semiconductor device 200, it further comprises at least one processor 240.

Furthermore, the memory 230 is also configured to store processor-executable instructions 232 which implement a step of correcting the baseline of the second Raman spectrum on the basis of at least one correction factor, so as to obtain a corrected second Raman spectrum which is representative of the baseline of the first Raman spectrum, the baseline being caused by the semiconductor device 200 during the acquisition of the first Raman spectrum.

In addition, the processor-executable instructions 232 also implement a step of subtracting the corrected second Raman spectrum from the first Raman spectrum.

Finally, the processor 240 is configured to execute the executable instructions 232.

Now that the features of the semiconductor device 200 have been described, a computer-implemented method will be described for calculating a correction factor to correct a baseline of a Raman spectrum.

### Third Aspect of the Invention: A Computer-Implemented Method for Calculating a Correction Factor to Correct a Baseline of a Raman Spectrum

As illustrated in FIG. 4, the invention also relates to a computer-implemented method 300 for calculating a correction factor for correcting a baseline of a Raman spectrum, acquired by the on-chip Raman sensor 110, in response to irradiation of at least one excitation radiation onto an analyte medium that has at least a first refractive index.

In practice, as described above in connection with the first aspect of invention, the on-chip Raman sensor 110 is configured to acquire a first optical spectrum, referred to as the first Raman spectrum, which comprises a plurality of discrete wavelengths and which is representative of the analyte medium.

In the invention, the computer-implemented method of 300 for calculating a correction factor comprises a step 310 of acquiring a second Raman spectrum by the on-chip Raman sensor 110, in response to the irradiation of at least one excitation radiation onto a predetermined reference medium which has at least a second refractive index different from the first refractive index.

In a first implementation, the predetermined reference medium is a continuous fluid medium (e.g. water, air, acetone, methanol, chloroform, toluene or glycerol).

In a second implementation, the predetermined reference medium is a continuous solid medium (e.g. graphite, silicon, corundum, diamond or quartz).

Next, the computer-implemented method 300 for calculating a correction factor, further comprises a first step 320 of calculation, by the processor, for each wavelength of the first Raman spectrum, of a first parameter, referred to as the first Raman conversion efficiency parameter, which describes the efficiency of Raman conversion for the on-chip Raman sensor 110 in the predetermined reference medium,

Then, the computer-implemented method 300 further comprises a second calculation step 330, by a processor, for each wavelength of the first Raman spectrum, of second parameter, referred to as the second Raman conversion efficiency parameter, which describes the efficiency of Raman conversion for the on-chip Raman sensor 110 in the analyte medium.

In an implementation of the computer-implemented method 300 for calculating a correction factor, the first calculation step 320 and the second calculation step 330 are carried out on the basis of an optical simulation of at least one optical mode (for example TE₀ or TM₀) of the optical waveguide of the on-chip Raman sensor 110.

Thus, the first calculation step 320 and the second calculation step 330 can be carried out on the basis of two or more optical modes of the optical waveguide of the on-chip Raman sensor 110.

For example, optical simulation software such as Zemax®, COMSOL Multiphysics®, FRED®, OpticStudio® or Lumerical® can be used.

In practice, this software should make it possible to model the geometry and materials of the on-chip Raman sensor 110 (i.e. all of its component elements), the analyte medium and the predetermined reference medium.

In addition, this software can allow the refractive index of the analyte medium and the predetermined reference medium to be varied independently or in combination.

Finally, the computer-implemented method 300 for calculating a correction factor comprises a third calculation step 340, by a processor, for each wavelength of the first Raman spectrum, of a correction factor which corresponds to a ratio between the first Raman conversion efficiency parameter and the second Raman conversion efficiency parameter.

In a first implementation of the computer implemented method 300 for calculating a correction factor, the third calculation step 340 comprises calculating a predetermined number of correction factors, the predetermined number being less than the total number of wavelengths of the first Raman spectrum. Then, the third calculation step 340 comprises interpolating the missing correction factors from all or part of the predetermined number of previously calculated correction factors.

In a second implementation of the computer-implemented method 300 for calculating a correction factor, the third calculation step 340 comprises dividing the first Raman conversion efficiency parameter by the second Raman conversion efficiency parameter.

In a particular implementation of the computer-implemented method 300 for calculating a correction factor, said method further comprises a step 350 of storing the correction factor in a database 121, each record of which is configured to associate a correction factor with an analyte medium, a predetermined reference medium, a working wavelength, a first refractive index of the analyte medium and a second refractive index.

In a variation of the particular implementation of the computer-implemented method 300 for calculating a correction factor, the database 121 can be filled by repeating all of the steps of the method while varying, independently or in combination, the following parameters: the analyte medium, the predetermined reference medium, the working wavelength, the first refractive index and the second refractive index.

In an alternative version of the particular implementation of the computer-implemented method 300 for calculating a correction factor, the following parameters may be added to the database 121: the polarisation and geometry of the on-chip Raman sensor 110 (i.e. all of its component elements), the analyte medium and the predetermined reference medium.

In a third implementation of the computer-implemented method 300 for calculating a correction factor, said method also comprises a step 360 of correcting the baseline of the second Raman spectrum, by a processor, on the basis of at least one correction factor, so as to obtain a corrected second Raman spectrum which is representative of the baseline of the first Raman spectrum, the baseline being caused by the on-chip Raman sensor 110 during the acquisition of the first Raman spectrum.

In an implementation of the computer-implemented method 300 for calculating a correction factor, the step 360 of correcting the second Raman spectrum comprises a multiplication of the second Raman spectrum by at least one correction factor associated with a wavelength of the first Raman spectrum.

In an alternative of the particular implementation of the computer-implemented method 300 for calculating a correction factor, said method further comprises a step 361 of selecting, by a processor, the correction factor in a database 121 as a function, at least, of the analyte medium, the predetermined reference medium, the first refractive index of the analyte medium, the second refractive index of the predetermined reference medium and the working wavelength.

Finally, the computer-implemented method 300 for calculating a correction factor comprises a known step 370 of subtracting the corrected second Raman spectrum from the first Raman spectrum.

The invention has been described and illustrated. However, the invention is not limited by the embodiments that have been presented. Indeed, numerous combinations of variants, alternatives, embodiments and implementations are possible without requiring substantial modifications of the invention. A person skilled in the art can deduce other variants, alternatives, embodiments and implementations from reading the description and the attached figures, and as a function of the economic, ergonomic and dimensional constraints to be met.

The invention may include numerous alternatives and applications other than those described above. In particular, unless indicated otherwise, the various structural and functional features of each particular implementation described above should not be considered as combined and/or as closely and/or inextricably linked to one another, but by contrast as simple juxtapositions. In addition, the structural and/or functional features of the various embodiments described above may be the subject, all or in part, of any different juxtaposition or any different combination.

Furthermore, in the invention, when an element is “designed” to perform a particular function, this means that this element is created specifically for the purpose of performing this particular function.

However, depending on requirements and available resources, it may be possible to use an existing element which is modified or adapted in order to fulfil this particular function, without requiring substantial modifications to the invention.

1. A system for calculating a correction factor to correct a baseline of a Raman spectrum acquired by at least one waveguide-enhanced Raman spectroscopy device, referred to as an on-chip Raman sensor, the system comprising:
the on-chip Raman sensor, which is designed to implement a waveguide-enhanced Raman spectroscopy technique and which, in response to irradiation of at least one excitation radiation on a continuous fluid medium to be studied, referred to as an analyte medium, having at least one first refractive index, is configured to acquire a first optical spectrum, referred to as a first Raman spectrum, which comprises a plurality of discrete wavelengths and which is representative of the analyte medium, and
at least one memory, and
at least one processor, wherein:
the on-chip Raman sensor comprises:
a substrate which defines at least one surface, and
at least one optical waveguide, which is formed in an optical transmission material, which is all or in part disposed on or in the substrate, and which is configured to guide at least one light beam at at least one working wavelength,
the memory is configured to store,
a database, each record of which is configured to associate a correction factor with an analyte medium, a predetermined reference medium, a working wavelength, a first refractive index of the analyte medium and a second refractive index of the predetermined reference medium,
instructions which are executable by a processor which implement,
a first calculation step, for each wavelength of the first Raman spectrum, of a first parameter, referred to as the first Raman conversion efficiency parameter, which describes an efficiency of Raman conversion for the on-chip Raman sensor in the predetermined reference medium,
a second calculation step, for each wavelength of the first Raman spectrum, of a second parameter, referred to as the second Raman conversion efficiency parameter, which describes an efficiency of Raman conversion for the on-chip Raman sensor in the analyte medium, and
a third calculation step, for each wavelength of the first Raman spectrum, of a correction factor which corresponds to a ratio between the first Raman conversion efficiency parameter and the second Raman conversion efficiency parameter, the correction factor being designed to correct the baseline of the second Raman spectrum,
each correction factor,
being designed to correct the baseline of a second optical spectrum, referred to as the second Raman spectrum, the baseline being caused by the on-chip Raman sensor, during the generation of the second Raman spectrum, in response to the irradiation of at least one excitation radiation on a predetermined reference medium which has at least one second refractive index different from the first refractive index, the second Raman spectrum comprising a plurality of discrete wavelengths and being representative of the predetermined reference medium,
correspondingly, for each wavelength of the first Raman spectrum, at a ratio between the first Raman conversion efficiency parameter and the second Raman conversion efficiency parameter,
the processor is configured to execute the executable instructions.

2. The system for calculating a correction factor according to claim 1, wherein the computer-executable instructions further implement:
a step of correcting the baseline of the second Raman spectrum on the basis of the correction factor, so as to obtain a corrected second Raman spectrum which is representative of the baseline of the first Raman spectrum, the baseline being caused by the on-chip Raman sensor during the acquisition of the first Raman spectrum, and
a step of subtracting the corrected second Raman spectrum from the first Raman spectrum.

3-4. (canceled)

5. A computer implemented method for calculating a correction factor to correct a baseline of a Raman spectrum acquired by at least one waveguide-enhanced Raman spectroscopy device, referred to as an on-chip Raman sensor, the on-chip Raman sensor being designed to implement a waveguide-enhanced Raman spectroscopy technology and which, in response to the irradiation of at least one excitation radiation on a continuous fluid medium to be studied, referred to as an analyte medium, having at least one first refractive index, is configured to acquire a first optical spectrum, referred to as a first Raman spectrum, which comprises a plurality of discrete wavelengths and which is representative of the analyte medium, the on-chip Raman sensor comprising:
a substrate which defines at least one surface, and
at least one optical waveguide which is formed in an optical transmission material, which is all or in part disposed on or in the substrate, and which is configured to guide at least one light beam at at least one working wavelength,
the method comprising:
a step of acquiring a second optical spectrum, referred to as the second Raman spectrum, by the on-chip Raman sensor, in response to the irradiation of at least one excitation radiation on a predetermined reference medium which has at least one second refractive index different from the first refractive index, the second Raman spectrum comprising a plurality of discrete wavelengths and being representative of the predetermined reference medium, the second-generation Raman spectrum causing formation of a baseline of the second Raman spectrum,
a first calculation step, by the processor, for each wavelength of the first Raman spectrum, of a first parameter, referred to as the first Raman conversion efficiency parameter, which describes an efficiency of Raman conversion for the on-chip Raman sensor in the predetermined reference medium,
a second calculation step, by the processor, for each wavelength of the first Raman spectrum, of a second parameter, referred to as the second Raman conversion efficiency parameter, which describes an efficiency of Raman conversion for the on-chip Raman sensor in the analyte medium, and
a third calculation step, by the processor, for each wavelength of the first Raman spectrum, of a correction factor which corresponds to a ratio between the first Raman conversion efficiency parameter and the second Raman conversion efficiency parameter, the correction factor being designed to correct the baseline of the second Raman spectrum.

6. The computer-implemented method for calculating a correction factor according to claim 5, wherein the first calculation step and the second calculation step are carried out on the basis of an optical simulation of at least one optical mode of the optical waveguide of the on-chip Raman sensor.

7. The computer implemented method for calculating a correction factor according to claim 5, wherein the third calculation step comprises a division of the first Raman conversion efficiency parameter by the second Raman conversion efficiency parameter.

8. The computer implemented method for calculating a correction factor according to claim 5, further comprising a step of storing, by a processor, the correction factor in a database, each record of which is configured to associate a correction factor with an analyte medium, a predetermined reference medium, a working wavelength, a first refractive index of the analyte medium and a second refractive index of the predetermined reference medium.

9. (canceled)

10. The computer implemented method for calculating a correction factor according to claim 5, wherein the predetermined reference medium is a continuous fluid medium.

11. The computer implemented method for calculating a correction factor according to claim 5, the method further comprising:
a step of correcting the baseline of the second Raman spectrum, by a processor, on the basis of the correction factor, thus enabling a corrected second Raman spectrum to be obtained, which is representative of the baseline of the first Raman spectrum, the baseline being caused by the on-chip Raman sensor during the acquisition of the first Raman spectrum, and
a step of subtracting, by a processor, the corrected second Raman spectrum from the first Raman spectrum.

12. The computer implemented method for calculating a correction factor according to claim 11, wherein the step of correcting the baseline of the second Raman spectrum comprises a multiplication of the second Raman spectrum by the correction factor associated with a wavelength of the first Raman spectrum.

13. The computer implemented method for calculating a correction factor according to claim 11, further comprising a step of selecting, by a processor, the correction factor in a database as a function, at least, of the analyte medium, the predetermined reference medium, the first refractive index of the analyte medium, the second refractive index of the predetermined reference medium and the working wavelength.

14-15. (canceled)

16. The system for calculating a correction factor according to claim 1, wherein the system is produced in the form of an integrated semiconductor device comprising,
the on-chip Raman sensor which is integrated in said integrated semiconductor device,
the memory which is produced in the form of an integrated memory, and
the processor which is produced in the form of an integrated processor.

17. A computer implemented method for calculating a correction factor according to claim 5, wherein the predetermined reference medium is a continuous solid medium.
